(19) United States
(12) Patent Application Publication
(10) Pub. No.: US 2012/0291580 A1
(43) Pub. Date: Nov. 22, 2012

(54) AUTOMATED MANUAL TRANSMISSION CONTROL APPARATUS

(75) Inventor: Young Ho KIM, Whasung-Si (KR)

(73) Assignee: Hyundai Motor Company, Seoul (KR)

(21) Appl. No.: 13/270,070

(22) Filed: Oct. 10, 2011

(30) Foreign Application Priority Data
May 18, 2011 (KR) 10-2011-0046571

(51) Int. Cl. F16H 59/02

(52) U.S. Cl. 74/473.12; 74/473.1

(57) ABSTRACT

An automated manual transmission control apparatus may include a cam rotatably provided on a center shaft, first power transmission assembly for transmitting power generated by rotational displacement of the cam to a shift lever as power to drive the shift lever, and second power transmission assembly for transmitting power generated by the rotational displacement of the cam to a release lever as power to drive the release lever.

### CROSS-REFERENCE TO RELATED APPLICATION

The present application claims priority to Korean Patent Application No. 10-2011-0046571, filed on May 18, 2011, the entire contents of which is incorporated herein for all purposes by this reference.

### BACKGROUND OF THE INVENTION

1. Field of the Invention

The present invention relates generally to an automated manual transmission control apparatus and, more particularly, to a control mechanism in which the operation of a clutch can be automatically interlocked with gear shifting.

2. Description of Related Art

Conventional automated manual transmissions include a clutch control unit which substitutes for clutch pedal manipulation by a driver, and a gear shift unit which substitutes for gear shifting manipulation by the driver. Such an automated manual transmission conducts a gearshift in such a way that the gear shift unit shifts a gear while the clutch control unit controls the clutch.

Therefore, a separate motor and operation mechanism are basically required to embody the clutch control unit. In addition, the gear shift unit also requires a separate motor and operation mechanism. In particular, a gearshift is classified into gear selecting operation and gear shifting operation. To embody this operation, a mechanism using a plurality of actuators, such as motors or the like, has been used.

As mentioned above, a conventional automated manual transmission control apparatus includes at least three actuators to control a clutch, select a gear, and shift the gear. Therefore, if the operation cycles of the actuators are not precisely harmonized with each other, there is a probability of malfunction. Thus, it is very difficult to control the gearshift process. Furthermore, because comparatively many actuators are used, the weight of the apparatus increases, and the production cost also increases.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an automated manual transmission control apparatus which is configured in such a way that the operation of a clutch is interlocked with the operation of shifting a gear by simple operation mechanism, thus preventing malfunction, making it easy to control the gearshift process, and reducing the weight and production cost of an automated manual transmission.

In an aspect of the present invention, the automated manual transmission control apparatus, may include a cam rotatably provided on a center shaft, first power transmission assembly for transmitting power generated by rotational displacement of the cam to a shift lever as power to drive the shift lever, and second power transmission assembly for transmitting power generated by the rotational displacement of the cam to a release lever as power to drive the release lever.

The first power transmission assembly transmits the power to the shift lever from a moment when transmitting the power of the second power transmission assembly may have been completed.

The first power transmission assembly may include a first rod rotatably connected to the cam in a predetermined distance from the center shaft, a second rod pivotally connected to the shift lever, and spring assembly elastically coupling the first rod and the second rod and being configured such that as a displacement of a distance between the first rod and the second rod may be reduced, an elastic modulus of the spring assembly increases by predetermined steps.

The spring assembly may include a first spring having a predetermined elastic modulus, and a second spring having an elastic modulus higher than the elastic modulus of the first spring, wherein the first spring and the second spring may be disposed in series along a linear line defined by the first rod and the second rod.

The spring assembly may include s a variable thickness spring aligned in a line with the first and second rods, the variable thickness spring varying in thickness of a spring wire when being compressed or stretched along the line.

The spring assembly further may include a housing wherein the first rod and the second rod may be slidably engaged to the housing, a first seat formed to an end of the first rod and a second seat formed to an end of the second rod may be slidably disposed in the housing, the first spring may be disposed between the first seat and inner surface of the housing and between the second seat and inner surface of the housing, and the second spring may be disposed between the first seat and the second seat.

The cam may have a clutch drive protrusion protruding outwards from a basic circle thereof, the basic circle being formed around the center shaft with a predetermined radius, and the second power transmission assembly may have a push rod slidably contacting the cam such that the push rod linearly moves while following a profile of the clutch drive protrusion so as to transmit a linear displacement thereof to the release lever, wherein the clutch drive protrusion may have upper and lower clutch drive protrusions respectively provided on the cam at upper and lower symmetric positions with respect to the push rod, and each of the upper and lower clutch drive protrusions may be configured such that when the cam rotates until the shift lever may have completed a gearshift, the push rod may be brought into contact with the basic circle and may be returned to an original position thereof.

An actuator may be connected to the center shaft of the cam to provide rotating force to the cam, the push rod may be guided by a guide bracket when the push rod linearly moves, and a roller may be provided on a corresponding end of the push rod so that the push rod may be brought into rolling contact with the cam by the roller.

The actuator may be a motor.

In an automated manual transmission control apparatus according to the present invention, the operation of a clutch can be interlocked with the operation of shifting a gear by simple operation mechanism. Thus, the apparatus is prevented from malfunctioning. Controlling the gearshift process is facilitated. The weight and production cost of an automated manual transmission can be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is of views showing the construction of an automated manual transmission control apparatus, according to an exemplary embodiment of the present invention.

FIG. 2 is a schematic view illustrating the operation mechanism of the control apparatus of FIG. 1.

FIG. 3 is of views illustrating an upshift mechanism of the control apparatus of FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a preferred embodiment of the present invention will be described in detail with reference to the attached drawings.

Reference now should be made to the drawings, in which the same reference numerals are used throughout the different drawings to designate the same or similar components.

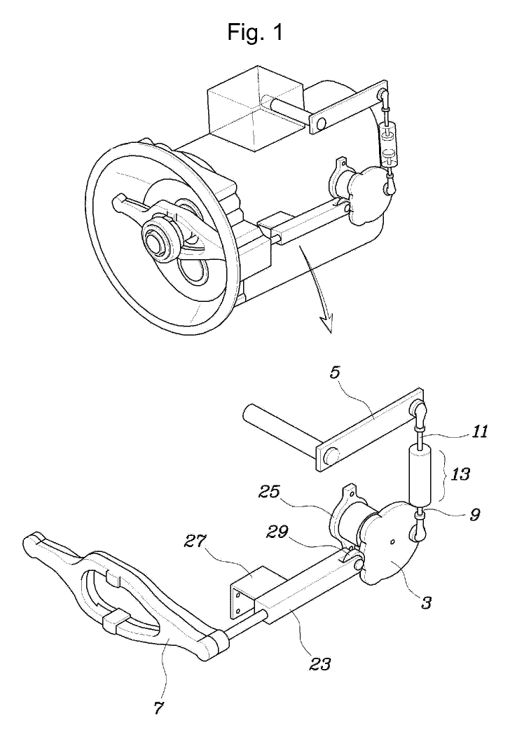

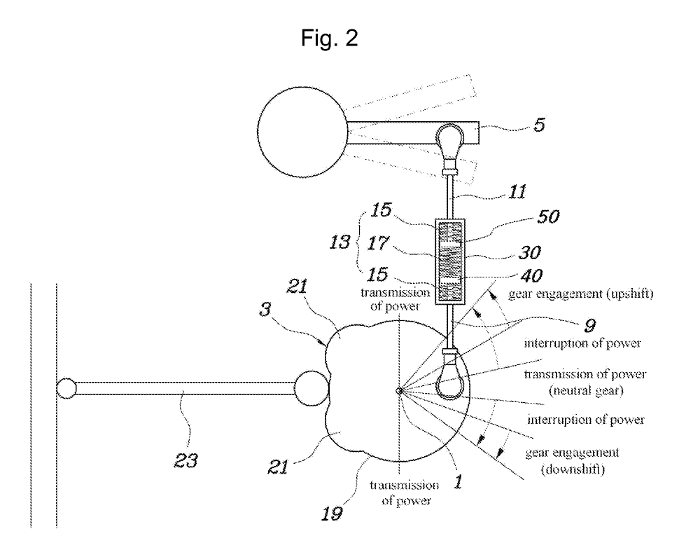

Referring to FIGS. 1 through 3, an automated manual transmission control apparatus according to the embodiment of the present invention includes a cam 3, a first power transmission assembly, and a second power transmission assembly. The cam 3 is rotatably provided on a center shaft 1. The first power transmission assembly transmits power generated by rotational displacement of the cam 3 to a shift lever 5 as power to drive the shift lever 5. The second power transmission assembly transmits power generated by rotational displacement of the cam 3 to a release lever 7 of a clutch as power to drive the release lever 7. The first power transmission assembly is configured in such a way that the first power transmission assembly transmits the power to the shift lever 5 from the moment when the power transmission of the second power transmission assembly has been completed.

In other words, the present invention is characterized in that the release lever 7 is operated by rotating the cam 3 and gear shifting is interlocked with the operation of the release lever 7. For reference, gear selecting operation is conducted by a separate method which is not mentioned in the present invention.

In the present embodiment, the first power transmission assembly includes a first rod 9, a second rod 11 and a spring assembly 13. The first rod 9 is rotatably connected to the cam 3. The second rod 11 is rotatably connected to the shift lever 5. The spring assembly 13 is configured in such a way that as displacement of the distance between the first rod 9 and the second rod 11 is reduced, an elastic modulus of the spring assembly 13 increases sequentially.

The spring assembly 13 includes a first spring 15 which has a relatively low elastic modulus, and a second spring 17 which has a relatively high elastic modulus. The first spring 15 and the second spring 17 are disposed in series along a straight line formed by the first and second rods 9 and 11.

In an exemplary embodiment of the present invention, the spring assembly 13 further includes a housing 30 wherein the first rod 9 and the second rod 11 are slidably engaged to the housing 30. Each end of the first and second rods 9 and 11 are formed with first and second seats 40 and 50.

The first spring 15 is disposed between the first seat 40 and inner surface of the housing and between the second seat 50 and inner surface of the housing. The second spring 17 is disposed between the first seat 40 and the second seat 50.

As such, in the present invention, the springs having different elastic moduli are disposed in series. Hence, when compression force is applied between the first rod 9 and the second rod 11, the first spring 15 that has a relatively low elastic modulus is first compressed, and after the first spring 15 has been compressed to a predetermined degree, the second spring 17 is compressed, thus providing elastic force.

In addition, for example, the spring assembly 13 may comprise a variable thickness spring that is aligned in line with the first and second rods 9 and 11 and varies in thickness of a spring wire while being compressed or stretched along the line.

The cam 3 includes a clutch drive protrusion 21 which protrudes in a streamline shape outwards from a basic circle 19 that is formed around the center shaft 1 with a predetermined radius. The second power transmission assembly comprises a push rod 23 which linearly moves along the profile of the clutch drive protrusion 21 so that a linear displacement is transmitted to the release lever 7 of the clutch.

In other words, as the cam 3 rotates, the clutch drive protrusion 21 pushes the push rod 23 so that the release lever 7 is operated.

The clutch drive protrusion 21 comprises upper and lower clutch drive protrusions 21 that are respectively provided on the cam at upper and lower symmetric positions with respect to the push rod 23. The clutch drive protrusions 21 are configured in such a way that when the cam 3 rotates until the shift lever 5 has completed a gearshift, the push rod 23 is brought into contact with the basic circle 19 and is returned to its original position.

Therefore, the upper clutch drive protrusion 21 participates in the operation of rotating the shift lever 5 upwards from a neutral state to upshift. The lower clutch drive protrusion 21 participates in the operation of rotating the shift lever 5 downwards from the neutral state to downshift.

Meanwhile, a motor 25 is connected to the center shaft 1 of the cam 3 to provide rotating force to the cam 3. The push rod 23 is guided by a guide bracket 27 when it linearly moves. A roller 29 is provided on a corresponding end of the push rod 23 so that the push rod 23 is brought into rolling contact with the cam 3 by the roller 29.

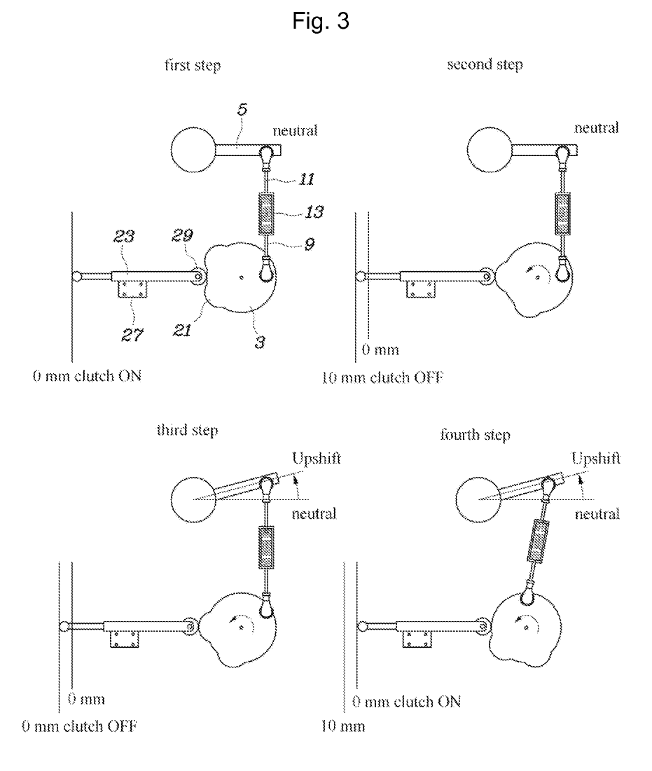

The operation of the automated manual transmission control apparatus to upshift will be described with reference to FIG. 3. Meanwhile, in the same manner, downshifting can be realized only by rotating the cam 3 in the direction opposite to that of upshifting.

A first step is the neutral state. The clutch is in an engaged state, in other words, in an ON state. The shift lever 5 is in the neutral state.

In this state, when the motor 25 is operated to rotate the cam 3, a second step is conducted. At the second step, the clutch drive protrusion 21 pushes the push rod 23. Then, the push rod 23 transmits linear movement force to the release lever 7 so that the clutch enters a disengaged state.

Furthermore, at the second step, the shift lever 5 maintains the neutral state. The reason for this is that when the cam 3 rotates to the degree described above, a displacement where the first rod 9 is moved toward the second rod 11 by the rotation of the cam 3 can compress only the first spring 15 but cannot yet compress the second spring 17. In addition, another reason for this is that the shift lever 5 is configured in such a way that it maintains the stationary state until a predetermined intensity of force is applied thereto so that only when force greater than a predetermined intensity is applied thereto can the shift lever 5 rotate, rather than continuously rotating in response to a variation of the intensity of force applied thereto.

Subsequently, when the cam 3 further rotates to enter a third step, the push rod 23 is still in the pushed state so that the clutch can still interrupt power transmission. Furthermore, the displacement of the first rod 9 further increases so that the second spring 17 is compressed beyond a limit where it can provide elastic force. Then, the shift lever 5 comes out of the neutral state, thus upshifting.

Thereafter, when the cam 3 further rotates, the control apparatus enters a fourth step. At the fourth step, as the cam 3 further rotates from the third step, the push rod 23 is returned to the basic circle 19 of the cam 3 so that the clutch enters the engaged state to allow power transmission again. Substantially the upshifting has been completed. Of course, in this state, the shift lever 5 continuously maintains the state in which the upshifting has been completed.

As described above, in an automated manual transmission control apparatus according to the present invention, the operation of shifting a gear can be conducted in sequential order in conjunction with the operation of controlling a clutch only by rotating a single motor at a predetermined angle in one direction. Therefore, the present invention can embody the operation of the clutch and the gear shifting operation together using the simple and inexpensive construction and the simple control method.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An automated manual transmission control apparatus, comprising:
a cam rotatably provided on a center shaft;
a first power transmission assembly for transmitting power generated by rotational displacement of the cam to a shift lever as power to drive the shift lever; and
a second power transmission assembly for transmitting power generated by the rotational displacement of the cam to a release lever as power to drive the release lever.

2. The automated manual transmission control apparatus as set forth in claim 1, wherein the first power transmission assembly transmits the power to the shift lever from a moment when transmitting the power of the second power transmission assembly has been completed.

3. The automated manual transmission control apparatus as set forth in claim 1, wherein the first power transmission assembly includes:
a first rod rotatably connected to the cam in a predetermined distance from the center shaft;
a second rod pivotally connected to the shift lever; and
spring assembly elastically coupling the first rod and the second rod and being configured such that as a displacement of a distance between the first rod and the second rod is reduced, an elastic modulus of the spring assembly increases by predetermined steps.

4. The automated manual transmission control apparatus as set forth in claim 3, wherein the spring assembly includes:
a first spring having a predetermined elastic modulus; and
a second spring having an elastic modulus higher than the elastic modulus of the first spring,
wherein the first spring and the second spring are disposed in series along a linear line defined by the first rod and the second rod.

5. The automated manual transmission control apparatus as set forth in claim 4, wherein the spring assembly includes a variable thickness spring aligned in a line with the first and second rods, the variable thickness spring varying in thickness of a spring wire when being compressed or stretched along the line.

6. The automated manual transmission control apparatus as set forth in claim 4, wherein:
the spring assembly further includes a housing wherein the first rod and the second rod are slidably engaged to the housing;
a first seat formed to an end of the first rod and a second seat formed to an end of the second rod are slidably disposed in the housing;
the first spring is disposed between the first seat and inner surface of the housing and between the second seat and inner surface of the housing; and
the second spring is disposed between the first seat and the second seat.

7. The automated manual transmission control apparatus as set forth in claim 1, wherein
the cam has a clutch drive protrusion protruding outwards from a basic circle thereof, the basic circle being formed around the center shaft with a predetermined radius, and
the second power transmission assembly has a push rod slidably contacting the cam such that the push rod linearly moves while following a profile of the clutch drive protrusion so as to transmit a linear displacement thereof to the release lever.

8. The automated manual transmission control apparatus as set forth in claim 7, wherein
the clutch drive protrusion has upper and lower clutch drive protrusions respectively provided on the cam at upper and lower symmetric positions with respect to the push rod, and
each of the upper and lower clutch drive protrusions is configured such that when the cam rotates until the shift lever has completed a gearshift, the push rod is brought into contact with the basic circle and is returned to an original position thereof.

9. The automated manual transmission control apparatus as set forth in claim 7 wherein
an actuator is connected to the center shaft of the cam to provide rotating force to the cam,
the push rod is guided by a guide bracket when the push rod linearly moves, and a roller is provided on a corresponding end of the push rod so that the push rod is brought into rolling contact with the cam by the roller.

10. The automated manual transmission control apparatus as set forth in claim 9, wherein the actuator is a motor.
